(19) United States
(12) Patent Application Publication
(10) Pub. No.: US 2014/0141897 A1
(43) Pub. Date: May 22, 2014

(54) DEVICE AND METHOD FOR PREPARING SCREW AND WASHER ASSEMBLIES

(71) Applicant: THALES, Neuilly-sur-Seine (FR)

(72) Inventor: Christophe FOURNIE, Frouzins (FR)

(21) Appl. No.: 14/081,918

(22) Filed: Nov. 15, 2013

(30) Foreign Application Priority Data
Nov. 16, 2012 (FR) 12 03070

(51) Int. Cl. B23P 19/08

(52) U.S. Cl. CPC B23P 19/08
USPC 470/3; 470/49

(57) ABSTRACT

A device for preparing screw and washer assemblies, each comprising a screw and washer to be disposed around the threaded shank of the screw, and a method using such a device, are provided. The device comprises a first rack for screws and a second rack for washers. The first rack has first recesses to orient the screws in one direction and orientation and predetermined arrangement. These are a first series of grooves for receiving the threaded shank of the screws and a second series of grooves for receiving the screw heads. The second rack has second recesses to position the washers in the same predetermined arrangement. These may be a third series of grooves, on the bottom of which the washers can come to bear. The first rack is formed on a first face of a plate and the second rack is formed on a second face of the plate.

### CROSS-REFERENCE TO RELATED APPLICATION

This application claims priority to foreign French patent application No. FR 1203070, filed on Nov. 16, 2012, the disclosure of which is incorporated by reference in its entirety.

### FIELD OF THE INVENTION

The invention lies in the field of mechanical assembly by screwing. It relates to a device for preparing screw and washer assemblies, each comprising a screw and a washer intended to be disposed around the threaded shank of the screw. The invention also relates to a method for preparing screw and washer assemblies using such a device.

### BACKGROUND

In the field of mechanical assembly by screwing, it is well known to use washers to increase the clamping surface area of the screw heads. A washer generally consists of a disc pierced with a hole in its centre to allow a threaded shank to pass through. The diameter of the pierced hole is substantially greater than the nominal diameter of the threaded screw, and the outside diameter of the disc is greater than the diameter of the screw head. Positioning washers around the threaded shanks of screws is a time-consuming operation since several hundreds or several thousands of screw and washer assemblies are prepared. In certain industries, for example the motor vehicle industry, assembly robots position a washer on each screw in an automated manner. However, such automation can prove to be inappropriate in other sectors, for example in the aerospace sector, for mounting equipment on satellites. In the latter sector, the production scale is insufficient to justify the installation of automated assembly lines. Furthermore, the use of assembly robots generally involves the formation of dust, the presence of which absolutely has to be avoided. Thus, positioning washers around screws is generally carried out manually by a worker. The worker places the screws individually alongside one another on an adhesive surface of a plate, the threaded shank of the screws being directed upwards, and then adds a washer around each screw. These operations become increasingly delicate as the dimensions of the screws and the washers become smaller. There is thus an additional risk of the screws and washers being knocked over during their preparation.

### SUMMARY OF THE INVENTION

One aim of the invention is notably to provide a device which has a simple and economical design and which makes it possible to form a plurality of screw and washer assemblies in a limited time period. To this end, one subject of the invention is a device for preparing screw and washer assemblies, where each assembly comprises a screw and a washer intended to be disposed around the threaded shank of the screw. The device comprises:
a first rack for the screws, having first recesses that are able to orient all the screws in one and the same direction and one and the same orientation and to position them in a predetermined arrangement, and
a second rack for the washers, having second recesses that are able to position said washers in the same predetermined arrangement.

The first rack is formed on a first face of a plate and the second rack is formed on a second face of the plate.

The number of elements of the device is thus limited.

The first recesses have for example a first series of grooves for receiving the threaded shank of the screws and for aligning the screws in lines. They may also have a second series of grooves for wedging the screws along the grooves of the first series. The grooves of the first series are for example substantially straight and parallel to one another.

The second recesses have for example a third series of grooves, on the bottom of which the washers may come to bear. The height of these grooves may be greater than or less than the thickness of the washers. According to a particular embodiment, the second rack has a fourth series of grooves so as to allow a threaded screw shank to pass through each washer beyond the bottom of the grooves of the third series.

The device for preparing screw and washer assemblies may furthermore comprise a frame able to surround the first rack so as to retain the screws therein, the frame also being able to surround the second rack so as to retain the washers therein.

The device for preparing screw and washer assemblies advantageously comprises a support plate having an adhesive surface to which the heads of the screws are able to adhere.

A further subject of the invention is a method for preparing screw and washer assemblies, each assembly comprising a screw and a washer intended to be disposed around the threaded shank of the screw. The method comprises the following steps of:
pouring a set of screws onto a surface of a first rack, said rack comprising first recesses that are able to orient all the screws in one and the same direction and one and the same orientation and to position them in a predetermined arrangement,
shaking the first rack so that each screw is oriented and positioned in the first recesses,
placing an adhesive surface of a support plate on the heads of the screws so that all of the screws adhere to said plate in the predetermined arrangement,
removing the first rack,
pouring a set of washers onto a surface of a second rack, said rack comprising second recesses that are able to position the washers in the same predetermined arrangement,
shaking the second rack so that each washer is positioned in the second recesses,
placing the support plate with the screws on the second rack so as to make each threaded shank of the screws coincide with a hole in a washer,
turning over the support plate and the second rack so that the washers come to bear on a bearing surface of the screw heads under the effect of gravity,
removing the second rack.

The first rack is formed on a first face of a plate and the second rack is formed on a second face of the plate.

According to one particular embodiment, the method furthermore comprises a step which consists in surrounding the first rack with a first frame for retaining the screws on the surface of the first rack.

Similarly, the method may comprise a step which consists in surrounding the second rack with a second frame for retaining the washers on the surface of the second rack.

The invention has notably the advantage of making it possible to prepare screw and washer assemblies with small diameters without additional precision compared with screws and washers having larger diameters.

### BRIEF DESCRIPTION OF THE DRAWINGS

The invention will be better understood and further advantages will become apparent from reading the following description which is given with reference to the attached drawings, in which:

FIG. 1 shows a perspective view of a device for preparing screw and washer assemblies according to the invention;

FIG. 2 shows a side view of the device from FIG. 1;

FIG. 3 shows a top view of the device from FIG. 1;

FIG. 4 shows a bottom view of the device from FIG. 1;

FIG. 5 shows a side view of an embodiment detail of a rack for the screws of the device from FIG. 1;

FIG. 6 shows a side view of an embodiment detail of a rack for the washers of the device from FIG. 1;

FIG. 7 shows an example of steps in the method for preparing screw and washer assemblies according to the invention.

### DETAILED DESCRIPTION

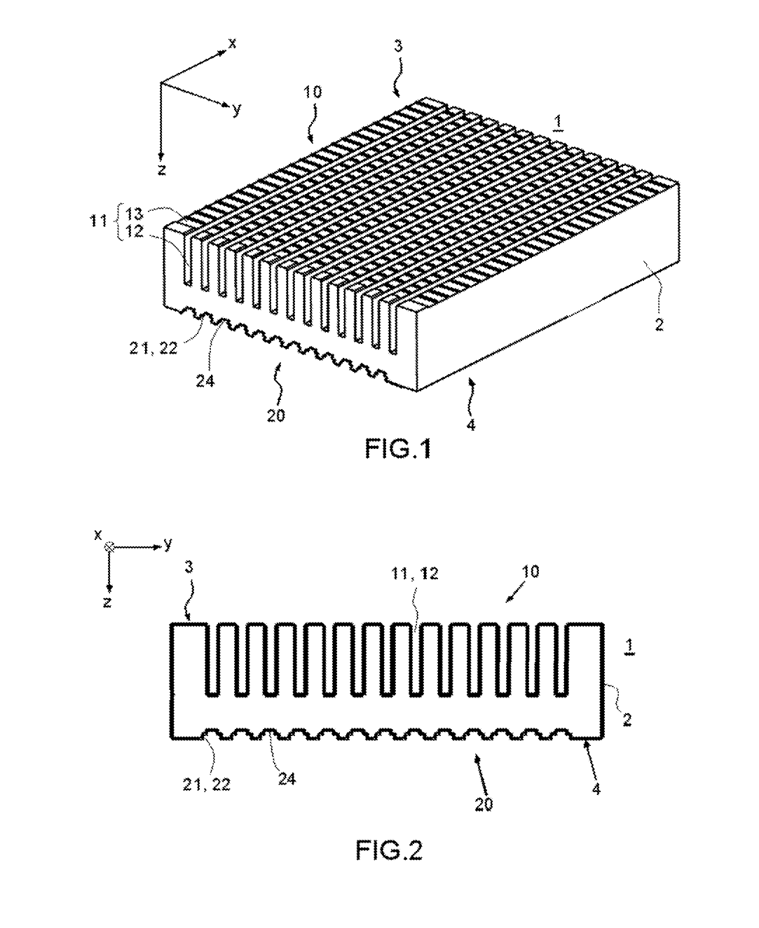

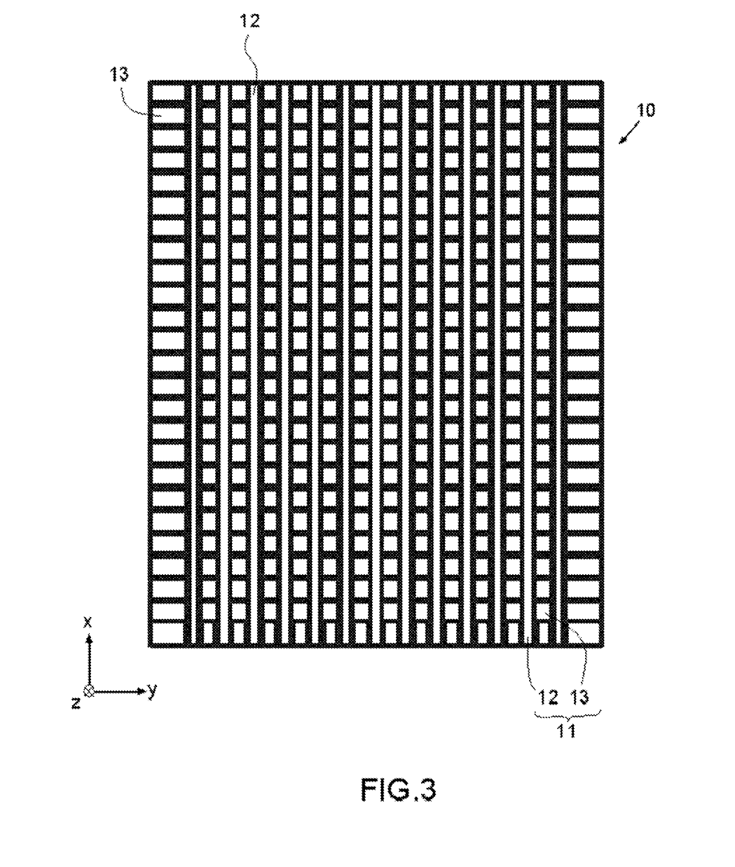

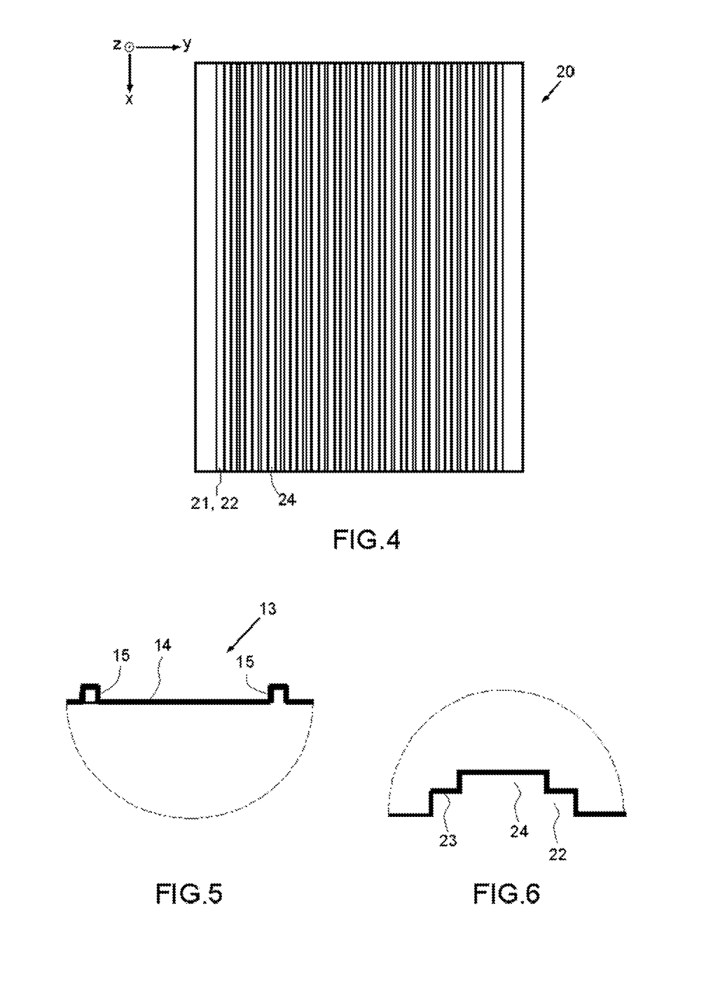

FIGS. 1 to 6 illustrate an exemplary embodiment of a device for preparing screw and washer assemblies according to the invention. FIGS. 1 to 4 show a perspective view, a side view, a top view and a bottom view, respectively, of the device and FIGS. 5 and 6 show side views of embodiment details of the device. As is shown more particularly in FIGS. 1 and 2, the device 1 is formed from a plate 2, for example made of aluminium, having a first surface 3 and a second surface 4 parallel to the first surface. The plate 2 also has a rack 10 for the screws, said rack 10 being formed on the first surface 3, and a rack 20 for the washers, said rack 20 being formed on the second surface 4. The rack 10 comprises recesses 11, the shape and dimensions of which are intended to allow a set of screws having identical dimensions to be oriented in one and the same direction and one and the same orientation. Specifically, all of the screws should be oriented in a manner parallel to an axis Z, and in the direction of this axis Z, that is to say that the screws should have their threaded shank directed downwards. The recesses 11 should also be able to position the screws in a predetermined arrangement. In other words, each screw should be positioned individually in one of the positions provided on the rack 10. In the exemplary embodiment shown, the recesses 11 have a first series of grooves 12 and a second series of grooves 13 produced in the plate 2 and opening onto the first surface 3. The grooves 12 of the first series are straight and parallel to the axis X. They are designed to receive the threaded shank of the screws but not their head. Thus, the width of the grooves 12 is greater than or equal to the nominal diameter of the threaded shank of the screws and strictly smaller than the diameter of the head of the screws. The depth of the grooves 12 should be at least equal to the length of the threaded shank of the screws. The grooves 12 thus make it possible to orient the screws in a manner parallel to the axis Z and in the direction of this axis Z, and also to align them in lines parallel to the axis X. The grooves 13 of the second series are straight and parallel to the axis Y. They are centred on axes that are spaced apart in pairs by a distance equal to the diameter of the outside diameter of the washers, and are designed to receive the head of the screws. In particular, the width of the grooves 13 is slightly greater than or equal to the maximum diameter of the head of the screws. The bearing surface of each screw head, that is to say the annular surface surrounding the non-free end of the threaded shank of the screw, may thus come to bear on the bottom 14 of a groove 13, the walls 15 of the grooves 13 forming means for wedging the screws along the grooves 12 of the first series, as is shown in FIG. 5. Overall, the grooves 12 and 13 of the first and second series make it possible to position the screws in a plane XY in a matrix arrangement, as is clearly apparent in FIG. 3. The rack 20 for the washers comprises recesses 21, the shape and dimensions of which are intended to make it possible to position the washers in the same predetermined arrangement. In the exemplary embodiment shown in FIG. 1, the recesses 21 are in the form of a third series of grooves 22 produced in the plate 2 and opening onto the second surface 4. The grooves 22 are straight and parallel to the axis X, in the same arrangement as the grooves 12 of the first series in the rack 10 for the screws. In particular, the grooves 22 are spaced apart in pairs at a distance identical to that between two adjacent grooves 12 in the rack 10. The grooves 22 of the third series are designed to receive washers, one of the bearing surfaces of the washers coming to bear on the bottom 23 of the grooves 22, as is shown in FIG. 6. In particular, the width of the grooves 22 is slightly greater than or equal to the outside diameter of the washers. The grooves 22 thus make it possible to align the washers alongside one another in lines parallel to the axis X. The rack 20 also preferably comprises a fourth series of grooves 24. The grooves 24 are straight and parallel to the axis X. Each groove 24 is produced in the bottom 23 of a groove 22. In other words, each groove 24 opens onto the bottom 23 of one of the grooves 22. The grooves 22 and 24 of the third and fourth series thus form what is known as a tiered groove. Each groove 24 is preferably centred with respect to the walls of the groove 22 in which it is inscribed. The grooves 24 are designed to be able to receive the free end of the threaded shank of the screws. They allow the free end of the threaded shank of each screw to pass through the washer beyond the bottom 23 of the grooves 22.

According to one particular embodiment, which is not shown, the rack 20 for the washers may also have means for wedging the washers along the grooves 22. In a similar manner to the rack 10 for the screws, these means may be in the form of grooves oriented in a manner substantially parallel to the axis Y. These grooves and the grooves 22 may also be replaced by radial bores at each position of a washer. Similarly, the grooves 24 could be replaced by concentric bores that are able to receive the threaded shanks of the screws.

The dimensions of the device for preparing screw and washer assemblies according to the invention depend of course on the dimensions of the screws and the washers. They depend in particular on the nominal diameter of the screws, on the length of the threaded shank thereof, on the maximum diameter of the head thereof, on the thickness of the washers and on the outside diameter thereof. According to one particular embodiment, the height of the grooves 22 in which the washers are accommodated is less than the thickness of the washers. This embodiment makes it possible to prevent a number of washers stacked on top of one another being held. By way of example, a number of dimensions of the device are given for screws having a nominal diameter equal to 4 millimetres (mm). In this example, the width of the grooves 12 of the first series and that of the grooves 24 of the fourth series are approximately equal to 4.2 mm. The width of the grooves 22 of the third series is equal to 7.95 mm, and the width of the grooves 13 is equal to 7.0 mm. The depth of the grooves 12 is equal to 50.0 mm. The depth of the grooves 13, that of the grooves 22 and that of the grooves 24 are equal to 0.5 mm, 1.2 mm and 1.0 mm, respectively.

In the exemplary embodiment shown in FIGS. 1 to 6, the screws were considered to have a flat head, that is to say a head having a substantially planar bearing surface, and that the washers were flat washers. However, the invention also applies to the case where the screw heads are countersunk. The recesses 11 in the rack for the screws are thus consequently adapted. Specifically, the grooves 13 of the second series may be replaced by countersunk holes that open onto the surface 3, one countersunk hole being produced at each location of a screw. Similarly, the washers may be spring washers, for example conical washers, the recesses 21 in the rack for the washers also being consequently adapted. In particular, the grooves 22 of the third series may be replaced by countersunk holes that open onto the surface 4, one countersunk hole being produced at each location of a washer.

Moreover, the rack for the screws and the rack for the washers were considered to be produced on two opposite faces of a single part. Specifically, such an embodiment has notably the advantage of simplifying the alignment of the means for positioning the screws, that is to say the recesses 11, with the means for positioning the washers, that is to say the recesses 21, during the production of the racks. Similarly, the alignment of the threaded shanks of the screws with the washers is made easier. Nevertheless, it is possible to produce the rack for the screws and the rack for the washers on two separate parts. The surfaces 3 and 4 of the plate 2, on which surfaces 3 and 4 the racks 10 and 20 are produced, were also considered to be planar and mutually parallel surfaces. Such surfaces are easy to produce. However, these surfaces may have a different profile, as long as the two surfaces have one and the same profile.

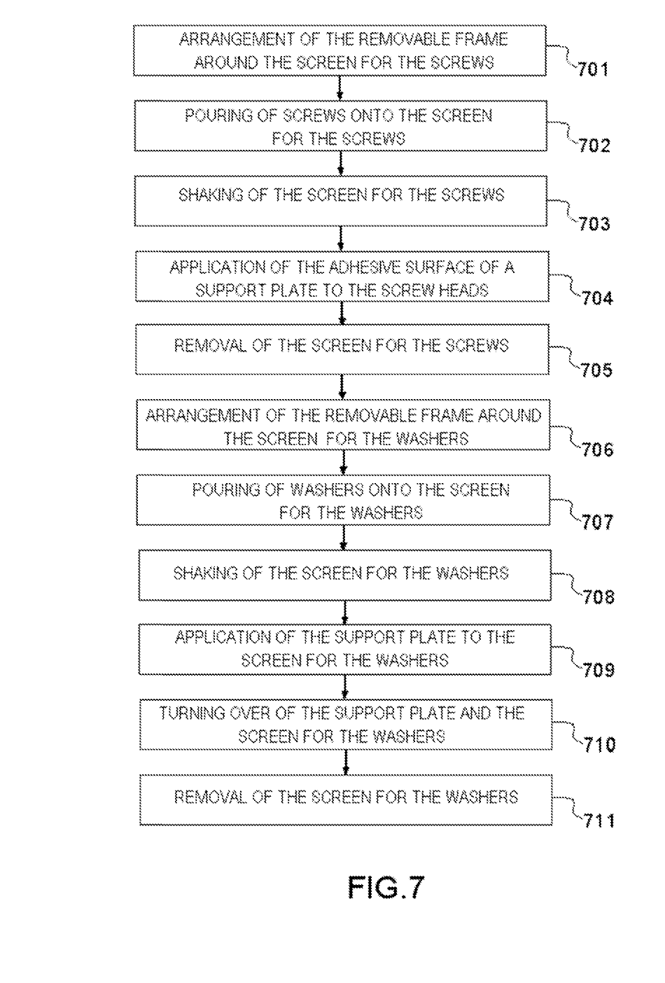

FIG. 7 shows an example of a method for preparing screw and washer assemblies according to the invention. This method is based on the use of the device for preparing screw and washer assemblies as described above. By way of example, the device 1 described with reference to FIGS. 1 to 6 will be considered to be used. In order to facilitate the use of this device, it is also possible to provide a removable frame that is able to surround the plate 2, and also a support plate designed to be introduced into the removable frame. Instead of using a removable frame, a frame may also be fixed around each of the surfaces 3 and 4 of the plate 2. The support plate comprises an adhesive surface having a profile identical to the profile of the surface 3 of the plate 2. The adhesive is for example a pressure-sensitive acrylic adhesive. In a first step 701, the removable frame is arranged around the plate 2 of the device 1, said plate 2 being positioned so that its surface 3 is oriented upwards. Thus, the rack 10 for the screws is accessible. In a second step 702, a set of screws having the same dimensions is poured onto the surface 3. The screws may be poured in bulk, that is to say without giving consideration to their position and orientation. In a third step 703, the plate 2 is shaken with the removable frame so that each screw is oriented and positioned in the recesses 11 in the rack 10 for the screws. In other words, the threaded shank of each screw slides into one of the grooves 12, and then its head is positioned in one of the grooves 13. In a fourth step 704, the adhesive surface of the support plate is brought into contact with the screw heads. The adhesive surface should make it possible for the screws to be held under the effect of their own weight. In a fifth step 705, the rack 10 is removed. This then gives a set of screws that are temporarily fixed by their head to the support plate. The screws are all oriented in a manner parallel to one another and are arranged in the form of a matrix. In a sixth step 706, the removable frame is arranged around the plate 2, said plate 2 being positioned so that its surface 4 is oriented upwards. Thus, the rack 20 for the washers is accessible. In a seventh step 707, a set of washers having the same dimensions is poured onto the surface 4. As for the screws, the washers may be poured in bulk. In an eighth step 708, the plate 2 is once again shaken with the removable frame so that each washer is positioned in the recesses 21 of the rack 20 for the washers. In particular, one of the bearing surfaces of each washer comes to bear against the bottom 23 of one of the grooves 22. In order to ensure that the washers are positioned correctly along the grooves 22, it is possible, at the end of step 708, to incline the plate 2 so that the washers come into contact with one another in each groove 22. In a ninth step 709, the support plate on which the screws are arranged is placed on the rack 20 for the washers so as to make each threaded shank of the screws coincide with the hole in a washer. This matching may notably be facilitated by the presence of the removable frame. In a tenth step 710, the support plate and the rack 20 for the washers are turned over. Under the effect of gravity, the washers come to bear on the bearing surface of the screw heads. The rack 20 for the washers may then be removed in a step 711. This then gives the same set of screws that is obtained after step 705, but with a washer placed on each screw. Advantageously, the number of washers poured onto the rack 20 during step 707 is greater than the number of screws poured onto the rack 10 during step 702. Thus, it is possible to ensure that a washer will be present on each screw after the end of the method. In such a case, the washers which have not been inserted into the threaded shank of a screw fall off the rack 20 for the washers during the turning-over step 710.

1. A device for preparing screw and washer assemblies, each assembly comprising a screw and a washer intended to be disposed around the threaded shank of the screw, the device comprising:
a first rack for the screws, having first recesses that are able to orient all the screws in one and the same direction and one and the same orientation and to position them in a predetermined arrangement, and
a second rack for the washers, having second recesses that are able to position said washers in the same predetermined arrangement, the first rack being formed on a first face of a plate and the second rack being formed on a second face of the plate.

2. The device according to claim 1, wherein the first recesses have a first series of grooves for receiving the threaded shank of the screws and for aligning the screws in lines.

3. The device according to claim 2, wherein the first recesses have a second series of grooves for wedging the screws along the grooves of the first series.

4. The device according to claim 2, wherein the grooves of the first series are substantially straight and parallel to one another.

5. The device according to claim 3, wherein the grooves of the first series are substantially straight and parallel to one another.

6. The device according to claim 1, wherein the second recesses have a third series of grooves, on the bottom of which the washers can come to bear.

7. The device according to claim 6, wherein the height of the grooves of the third series is greater than the thickness of the washers.

8. The device according to claim 6, wherein the height of the grooves of the third series is less than the thickness of the washers.

9. The device according to claim 6, wherein the second rack has a fourth series of grooves so as to allow a threaded screw shank to pass through each washer beyond the bottom of the grooves of the third series.

10. The device according to claim 1, further comprising a frame able to surround the first rack so as to retain the screws therein, the frame also being able to surround the second rack so as to retain the washers therein.

11. The device according to claim 1, further comprising a support plate having an adhesive surface to which the heads of the screws are able to adhere.

12. A method for preparing screw and washer assemblies, each assembly comprising a screw and a washer intended to be disposed around the threaded shank of the screw, the method comprising:
pouring a set of screws onto a surface of a first rack, said first rack comprising first recesses that are able to orient all the screws in one and the same direction and one and the same orientation and to position them in a predetermined arrangement,
shaking the first rack so that each screw is oriented and positioned in the first recesses,
placing an adhesive surface of a support plate on the heads of the screws so that all of the screws adhere to said plate in the predetermined arrangement, removing the first rack,
pouring a set of washers onto a surface of a second rack, said rack comprising second recesses that are able to position the washers in the same predetermined arrangement,
shaking the second rack so that each washer is positioned in the second recesses,
placing the support plate with the screws on the second rack so as to make each threaded shank of the screws coincide with a hole in a washer,
turning over the support plate and the second rack so that the washers come to bear on a bearing surface of the screw heads under the effect of gravity, and
removing the second rack,
the first rack being formed on a first face of a plate and the second rack being formed on a second face of the plate.

13. The method according to claim 12, further comprising surrounding the first rack with a first frame for retaining the screws on the surface of the first rack.

14. The method according to claim 13, further comprising surrounding the second rack with a second frame for retaining the washers on the surface of the second rack.

15. The method according to claim 12, further comprising surrounding the second rack with a second frame for retaining the washers on the surface of the second rack.
